(19) United States
(12) Patent Application Publication
(10) Pub. No.: US 2016/0206909 A1
(43) Pub. Date: Jul. 21, 2016

(54) VOLATILE ORGANIC COMPOUND DISPOSAL

(71) Applicant: Paragon Waste Solutions, LLC., Golden, CO (US)

(72) Inventor: Fortunato Villamagna, Las Vegas, NV (US)

(21) Appl. No.: 15/000,938

(22) Filed: Jan. 19, 2016

Related U.S. Application Data
(60) Provisional application No. 62/104,563, filed on Jan. 16, 2015.

(51) Int. Cl. A62D 3/19; B01D 53/72

(52) U.S. Cl. CPC A62D 3/19; B01D 53/72; A62D 2101/20

(57) ABSTRACT

The VOC disposal system disclosed herein includes a plasma chamber and a vent chamber. The plasma chamber includes one or more bands of plasma igniters that produce a field of free radicals across a volume of the plasma chamber. Volatile Organic Compounds (VOCs) are introduced to the plasma chamber and react with the free radicals, breaking down the VOCs into component parts as the materials travel from the plasma chamber to the vent chamber.

### CROSS-REFERENCE TO RELATED APPLICATIONS

This application claims benefit and priority of U.S. Provisional Application Ser. No. 62/104,563 filed on Jan. 16, 2015 entitled “VOLATILE ORGANIC COMPOUND DISPOSAL,” which is incorporated herein by reference in its entirety. Furthermore, this application incorporates by reference, U.S. Pat. No. 8,870,735, issued on Oct. 28, 2014 and entitled “WASTE DISPOSAL” for all that it discloses, in its entirety.

### FIELD

Implementations disclosed herein relate, in general, to information methods and systems for disposal of material.

### DISCUSSION OF RELATED ART

VOC disposal is a major problem in modern economies. As the consumption of products increase per capita, so does the generation of waste material. Various systems used for VOC disposal include household VOC disposal systems, industrial VOC disposal systems, hospital VOC disposal systems, etc. Typical household VOC disposal systems include expensive and environmentally unfriendly trucking and landfill operations. Industrial waste from factories, refineries, etc., is generally disposed of using methods that involve burning the waste and generating hothouse gases such as carbon dioxide, methane, etc. These existing VOC disposal systems are typically energy inefficient and environmentally unfriendly. Furthermore, due to the composition of the exhaust generated by such existing VOC disposal systems, they do not meet various guidelines and requirements of the environmental protection agency (EPA).

### BRIEF DESCRIPTION OF THE DRAWINGS

A further understanding of the nature and advantages of the present technology may be realized by reference to the figures, which are described in the remaining portion of the specification. In the figures, like reference numerals are used throughout several figures to refer to similar components.

FIG. 1 illustrates a partial cross sectional view of an example volatile organic compound (VOC) disposal system disclosed herein.

FIG. 2 illustrates a side view of an example VOC disposal system disclosed herein.

FIG. 3 illustrates an overhead cross sectional view of an example VOC disposal system disclosed herein.

FIG. 4 illustrates a top cross sectional view of a band of plasma igniters of a plasma chamber of an example VOC disposal system disclosed herein.

FIG. 5 illustrates example operations for disposing of waste using the VOC disposal system disclosed herein.

FIG. 6 illustrates alternative example operations for disposing of VOCs using the VOC disposal system disclosed herein.

### DETAILED DESCRIPTION

Implementations of the present technology are disclosed herein in the context of a volatile organic compound (VOC) disposal system. In the following description, for the purposes of explanation, numerous specific details are set forth in order to provide a thorough understanding of the present invention. It will be apparent, however, to one skilled in the art that the present invention may be practiced without some of these specific details. For example, while various features are ascribed to particular implementations, it should be appreciated that the features described with respect to one implementation may be incorporated with other implementations as well. By the same token, however, no single feature or features of any described implementation should be considered essential to the invention, as other implementations of the invention may omit such features.

A disposal system disclosed herein converts VOCs into benign and useful output. An example implementation of the disposal system provides for injecting a stream containing VOCs into a volume or field of free radicals. In this example implementation, the VOCs may not be produced from solid waste. The VOCs may be a product of stray vapors from transfer or storage units (e.g., transfer from tanks to trucks, trucks to smaller containers), emissions from dissolved gasses (e.g., DAF units in refineries, gasses from soils, landfill emissions), other emissions of combustible gasses with near zero BTU value. The VOCs may have a concentration in the low parts per million (ppm), for example, Furthermore, the VOCs may have an energy value of value of near 0 BTU/g (e.g., less than 1 BTU/g) and may consist of hydrocarbons, water vapor, inert gasses, air, soot, inorganic particulates, oil droplets, etc.

To maintain the direction of flow in the disposal system and to minimize back-draft reactions (which may potentially result in negative consequences), an implementation of the disposal system uses one-way valves. Furthermore, the disposal system disclosed herein provides for a mechanism to detect a pressure event and a pressure relief system that opens in response to detection of the pressure event.

The field of free radicals, such as those generated in a low energy or “cold” plasma, reacts with the VOCs, initiating a series of reactions that breaks apart the components of VOCs. In an implementation, the VOCs are generated from one or more streams such as flocculation or air flotation systems, solvent transfer operations, solvent drumming applications, landfill emissions, etc. In an alternative implementation, the waste product is the waste generated from a refinery, a chemical factory, other industrial facility, etc. The disposal system disclosed herein generates output that is environmentally friendly and generally in compliance with various environmental protection agency (EPA) regulations.

The disposal system disclosed herein can be used to destroy hazardous chemical waste produced in environmental and cleaning services, emission and vapor control technologies, waste destruction system and services, renewable energy systems, oil and gas exploration and production, refining, transportation, hydraulic fracking, landfills, food, beverage and agriculture, waste management and process emissions. The disclosed plasma system uses a free radical accelerated oxidation process to decompose the VOC particles. Furthermore, the disclosed plasma system increases the oxidation rate and energy efficiency when compared to typical thermal oxidizers.

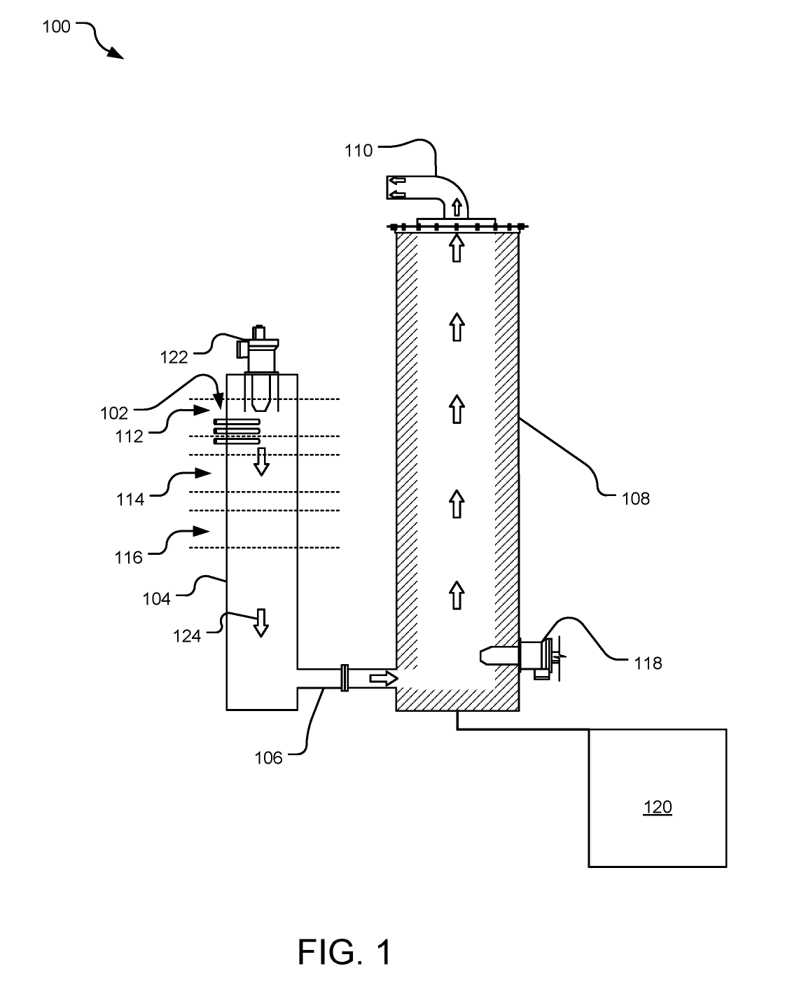

FIG. 1 illustrates a partial cross sectional view of an example VOC disposal system 100 disclosed herein. The VOC disposal system includes receiving pipes 102, a plasma chamber 104, a connecting pipe 106, a vent chamber 108, an exhaust pipe 110, and a control system 120.

The receiving pipes 102 receive various volatile organic compounds (VOCs) produced from waste. The VOC disposal system 100 is shown having three receiving pipes 102, but it should be understood that other configurations are contemplated. The receiving pipes 102 introduce VOCs into the plasma chamber 104.

In the illustrated implementation, the plasma chamber 104 is a substantially cylindrical chamber that includes a number of plasma igniters (not shown) that inject a stream of electrons into the chamber. In an alternative implementation, the plasma chamber 104 may have another shape than cylindrical. The stream of electrons causes various components of the air inside the plasma chamber to be ionized, generating cold plasma containing a stream of free radicals, such as peroxides, superoxides, hydroxyl and other reactive oxygen species. etc.

The term plasma is used herein to refer to a gas consisting of a single compound or a plurality of compounds in which a certain portion of the molecules are ionized. For example, plasma may be generated through a cascade of electrons colliding with gaseous molecules, thus turning the gas into plasma that contains charged particles, positive ions, negative electrons, et. A plasma is referred to as cold plasma if a small fraction of the gas molecules is ionized. Typically, cold plasma exists at temperatures from room temperature to up to a few thousand degrees Celsius.

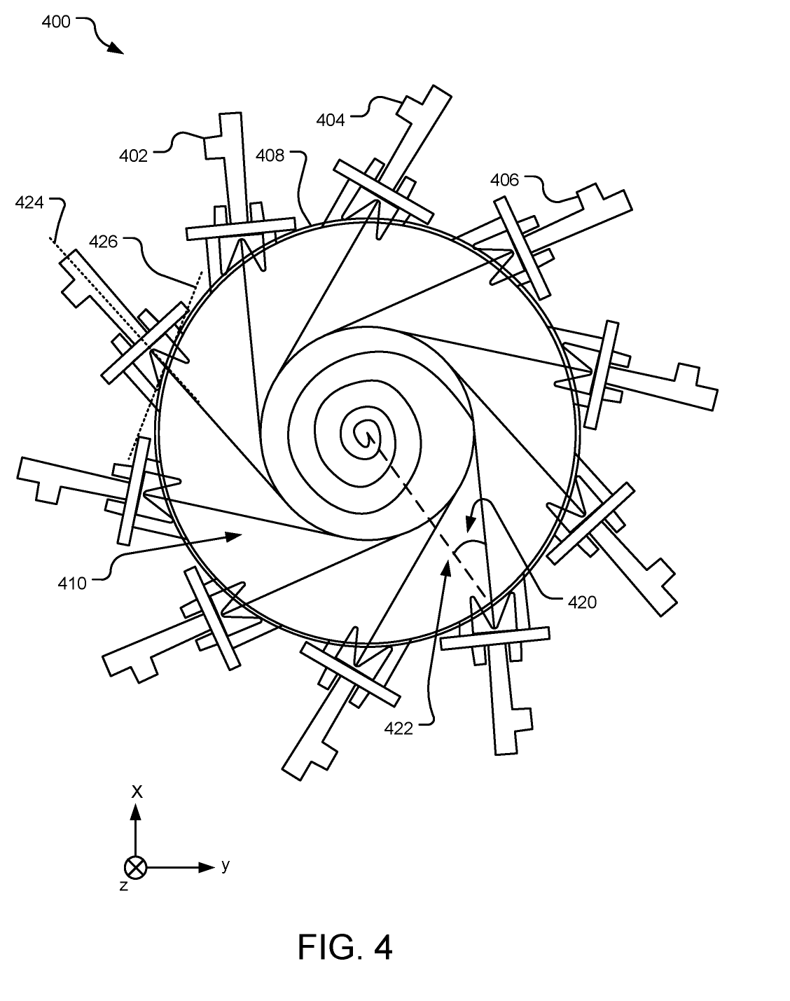

The plasma igniters are geometrically arranged such that a cross sectional volume of the plasma chamber is substantially filled with plasma (i.e., a section of the plasma chamber 104 contains a high concentration of free radicals). For example, a band (e.g., bands 112, 114, and 116) of plasma igniters may be arranged around the circumference of the side of the plasma chamber 104 (See FIG. 4 for an example arrangement of plasma igniters). The plasma igniters may be angled in a manner such that the plasma fills the chamber. A band (e.g., the band 112) of plasma igniters may fill approximately 6 vertical inches of the plasma chamber, so a number of bands (e.g., bands 112, 114 and 116) of plasma igniters may be placed along the longitudinal axis of the plasma chamber 104 to fill a desired height of the plasma chamber 104. The VOC disposal system is illustrated having three bands 112, 114, and 116 of plasma igniters on the plasma chamber 104, however, it should be understood that other configurations are contemplated. The amount of bands included on the plasma chamber 104 or used during the disposal process may depend on the type and amount of material to be destroyed.

A heating element 122 may be positioned on the plasma chamber. The heating element 122 may operate in conjunction with a heating element 118 to heat VOC disposal system 100 to a desired temperature and keep the VOC disposal system 100 within a desired temperature range

The plasma chamber 104 is connected to the vent chamber 108 via the connecting pipe 106. The connecting pipe 106 is located near the bottom of each chamber so that any VOCs traveling through the VOC disposal system 100 will travel through substantially the entire plasma chamber 104 and the vent chamber 108.

The vent chamber 108 may be a substantially cylindrical chamber. In one implementation, the vent chamber 108 operates to keep certain particles decomposing after the particles leave the plasma chamber. Specifically, the vent chamber may assist in decomposition of larger particles that take longer to decompose than smaller particles. For example, a sample of medical waste may include hydrocarbon molecules, oil droplets, and soot particles. The hydrocarbon molecules are much smaller than the oil droplets and soot particles, and therefore will generally be substantially completely decomposed in the plasma chamber. The oil droplets and soot particles take much longer to decompose than the hydrocarbon molecules and will begin decomposing in the plasma chamber 104 and continue the decomposition process through the vent chamber 108.

The heating element 118 may be mounted on the vent chamber 108. The heating element 118 heats the VOC disposal system 100 to a desired temperature or keeps the VOC disposal system 100 within a desired temperature range. The heating elements 118 and 122 may be electrically connected to a control system 120. The control system 120 monitors and adjusts the various components of the system via sensors and control circuitry. For example, if the control system 120 detects that the system temperature is falling below a desired temperature range, then the control system 120 will direct the heating elements 118 and/or 122 to heat the system until the temperature reaches the desired range. The control system 120 may further contain a data logger that logs data from various sensors coupled to the VOC disposal system 100.

The heating elements 118 and 122 may include an electric heater, gas heater, fire heater or other type of heating component. The heating element 118 may further comprise a thermjet burner. The operating temperature range of the VOC disposal system 100 is reflective of the autoignition point of the constituent VOCs. Generally, the operating temperature is about two times the autoignition temperature of the VOCs. For example, VOCs produced from medical waste may have an autoignition temperature of around 700 degrees Fahrenheit, and VOCs produced from oil (e.g., benzene, a common contaminate in refineries) may have an autoignition temperature of around 800 degrees Fahrenheit. Thus, the operating temperature range for the system for breaking down VOCs produced from medical waste is 1450±50 degrees Fahrenheit. The operating temperature range for the system for breaking down VOCs produced from petroleum is 1600±50 degrees Fahrenheit. The various materials and gasses lose heat as they travel down the plasma chamber 104, and the heating element 118 operates to keep the temperature within the desired range, keeping the decomposition rate of the materials constant.

The vent chamber 108 is connected to the exhaust pipe 110. The exhaust pipe 110 discharges decomposed materials to the environment safely and without impact to the environment.

Once the VOCs are introduced to the VOC disposal system 100 via the receiving pipes 102, the VOCs will enter the plasma chamber 104 wherein bands (e.g., the bands 112, 114, and 116) of plasma igniters are injecting electrons into the plasma chamber 104, causing a cross sectional volume of the plasma chamber 104 to contain a field of free radicals. The different bands of plasma igniters may operate at different temperatures. For example, band 12 may operate at a range of 1000 to 1500 degrees Fahrenheit, band 114 may operate at a range of 1600 to 2200 degrees Fahrenheit, and band 116 may operate at a range of 1400 to 1600 degrees Fahrenheit.

Because the plasma igniters are geometrically aligned in a manner such that the field of free radicals fills substantially the entire volume of the plasma chamber 104, even a low concentration of VOCs will react with the free radicals resulting in decomposition of the VOCs into component particles. For example, the component particles may include alkyl radicals, various reactive oxygen species such as singlet oxygen, hydroxyl radicals, superoxides, peroxides, etc. The VOCs may continue to react with the free radicals as the components travel through the VOC disposal system 100. The exhaust pipe 110 causes a draw or pull throughout the VOC disposal system 100, and pressure differences in the VOC disposal system 100 cause the VOCs and other particles to travel through the system. Arrows (e.g., an arrow 124) show the direction of travel of the VOCs and other particles. A minimum pressure to keep the material moving through the system may be equivalent to pressure of five inches of water or about ⅙ psi.

The arrangement of the plasma chamber 104 and the vent chamber 108 allows the residence time of the introduced VOCs to be maximized. Because the two chambers are side by side, the particles to be destroyed are inhibited from being arbitrarily sucked out of the system by the exhaust pipe 110. The VOCs may take approximately 5 seconds to travel through the VOC disposal system 100 (e.g., a 5 second residence time), but the residence time may be adjusted by the various components of the system depending on the material to be decomposed. For example, the residence time can be changed by the different flow rates created by the fans driving the VOC' s as well as added air.

Furthermore, the amount of plasma formed in the plasma chamber 104 depends on the type and amount of materials (VOCs) to be destroyed. Each igniter has been shown to create at least 10²⁰ or more particles/cm³, and the combination of a series of igniters creates an environment where the VOC concentration can be comparable to the radical generation.

The VOC disposal system 100 may further include a number of other control and safety components (not shown). The control and safety components may include a number of valves and fans and a pressure relief system. One or more fans may be included to help with the flow of the system, or the fans may be used as safety components. Furthermore, the fans may be configured according to the material being introduced to the system. For example, if hydrocarbons are introduced for decomposition, the fans will need to be explosion proof. If alcohol droplets are being introduced, then the seals on the fan need to be configured accordingly. These fans may act as a safety component and may be positioned in an area near the heating elements 118 and 122. For example, if a surge of hydrocarbons enters the system, the temperature may spike, and the fans may respond by flooding the system with air to cool it down. These safety components may be controlled by the control system 120.

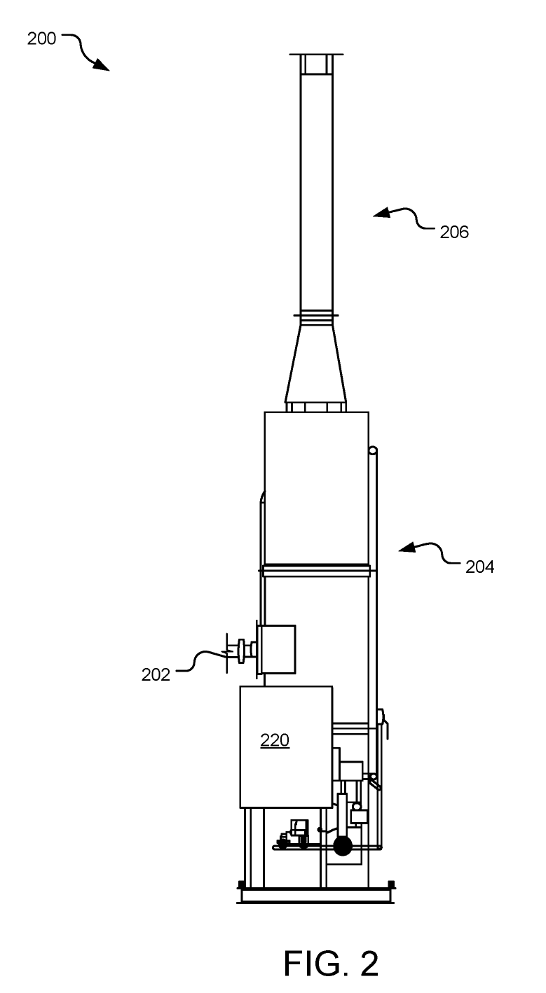

FIG. 2 illustrates a side view of an example VOC disposal system 200 disclosed herein. The VOC disposal system 200 includes receiving pipes 202 a vent chamber 204, a discharge zone 206, and a control system 220.

The receiving pipes 202 receive various volatile organic compounds (VOCs) produced from waste and introduces the VOCs to a plasma chamber (not shown). The VOCs enter the plasma chamber and begin reacting with free radicals introduced by a number of plasma igniters (not shown). The VOCs continue to react as they travel through the plasma chamber (not shown) and the vent chamber 204 until the reaction is substantially complete and the component particles of the VOCs are discharged from the VOC disposal system 200 through the discharge zone 206.

The control system 220 measures operating parameters and controls the various components of the VOC disposal system 200. The control system 220 may be electrically connected to a number of sensors that measure the operating parameters. For example, the control system 220 may be connected to a heating element (not shown) that can add heat to the system if the system falls outside a desired temperature range.

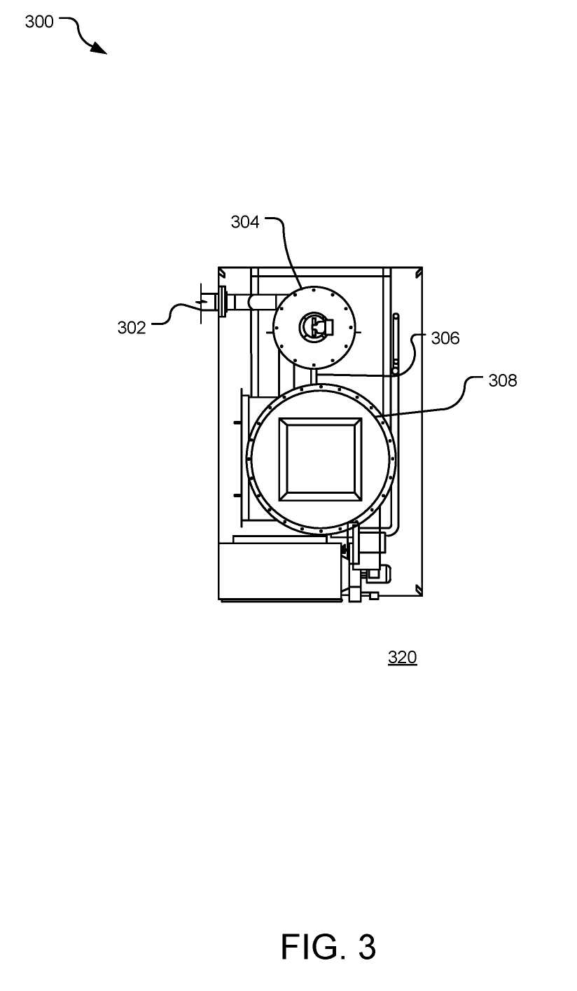

FIG. 3 illustrates an overhead cross sectional view of an example VOC disposal system 300 disclosed herein. The VOC disposal system 300 includes a receiving pipe 302, a plasma chamber 304, a connecting pipe 306 and a venting chamber 308. The receiving pipe 302 receives waste VOCs that travel to the plasma chamber 304. The plasma chamber 304 may contain a number of geometrically arranged bands of plasma igniters (not shown) that inject a stream of electrons into the chamber, which causes various components of the plasma chamber to be ionized, generating cold plasma containing a stream of free radicals, such as those listed above with respect to FIG. 1. The VOCs begin reacting with free radicals in the plasma chamber 304 and continue traveling to the vent chamber 308 via the connecting pipe 306. Reactions continue to take place as the VOCs and broken down component parts travel through the vent chamber 308. The component parts eventually leave the system through a discharge pipe (not shown).

FIG. 4 illustrates a top cross sectional view of a band of plasma igniters 400 of a plasma chamber of an example VOC disposal system disclosed herein. The band of plasma igniters 400 includes a number of plasma igniters (e.g., plasma igniters 402, 404 and 406) mounted around a wall 408 of the plasma chamber of the VOC disposal system. Each plasma igniter (e.g., the plasma igniter 402) injects a stream of electrons into the interior of the plasma chamber, which causes various components of the plasma chamber to be ionized, generating a cone of cold plasma containing a field of free radicals, such those listed above with respect to FIG. 1.

Each plasma igniter (e.g., the plasma igniters 401, 404, and 406) creates a natural disperse flow of radicals, which forms at a specific angle relative to the igniter. The geometry of the disperse flow of radicals produced by the plasma igniters (e.g., plasma igniters 402, 404 and 406) and the geometry of the chamber can be used to calculate the fill volume of the plasma. The plasma igniters (e.g., plasma igniters 402, 404 and 406) are adjustable in the x-axis and y-axis direction (e.g., sideways) and the z-axis direction (e.g., in a direction perpendicular to a plane defined by x-y or perpendicular to the drawing) and can be geometrically arranged to maximize the volume of plasma produced and maximize the overlap volume of individual plasma igniters (e.g., plasma igniters 402, 404, and 406) as well as overlap volume of separate bands of plasma igniters. Specifically, the angle between an axis 424 of the plasma igniters 402, 404, and 406 and a circumferential tangent 426 can be adjusted. Also, an angle between the axis 424 of the plasma igniters 402, 404, and 406 and tangent along the height of the plasma chamber (not shown) can also be adjusted Lines 410 show the flow direction of the plasma containing the field of free radicals. In the illustrated implementation, each of the plasma igniters 402-406 inject electrons into the plasma chamber at a non-zero angle 420 to the radius 422 of the plasma chamber. Such positioning and angling of the plasma igniters 402-406 allows the electron stream from each of the plasma igniters 402-406 to interject each other at a point other than the center of the plasma chamber and causes the plasma chamber to be substantially completely covered by the subsequent plasma generated by such electrons. Discrete measurements of certain radical species in a model system have shown that the concentration of radicals in the entire space, after steady state is achieved, to be of the order of 10²¹ particles per cubic centimeter. Total radical concentration in the system may be much higher than 10²¹ particles/cm³.

A number of bands of plasma igniters 400 can be arranged along the length of the plasma chamber to achieve a substantially homogenous volume of plasma along the desired length of the plasma chamber. When the volume of plasma is maximized in this manner, even a small concentration of VOCs introduced into the VOC disposal system may react with the plasma to result in decomposition and to form useful or benign component parts.

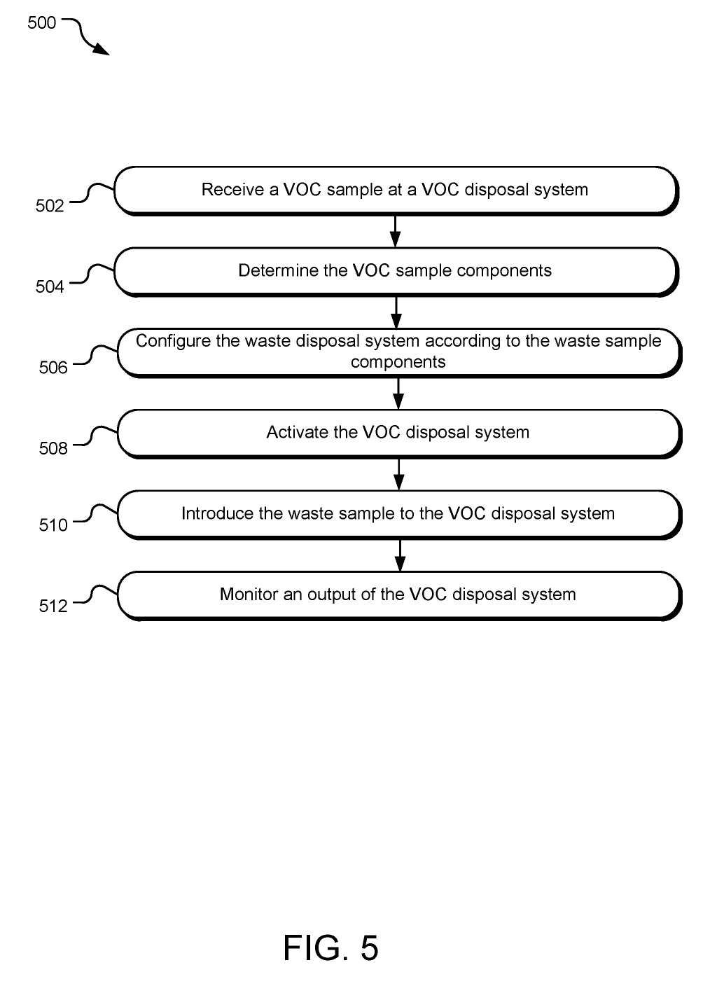

FIG. 5 illustrates example operations 500 for disposing of waste using the VOC disposal system disclosed herein. A receiving operation 502 receives a waste sample at a VOC disposal system. The waste sample may be received from a hospital, oil refinery, a fracking operation, landfill, hydrocarbon spills or releases, etc. The waste sample may be piped directly into the VOC disposal system from the source facility or transported to the waste system. Furthermore, the VOC disposal system may be moved to the source facility. A determining operation 504 determines the waste sample components. The waste sample components may be known by the source facility or may be determined by testing the waste sample.

A configuring operation 506 configures the VOC disposal system according to the waste sample components. Configuration operation may include: configuring a number of plasma igniters to produce a desired amount of free radicals (e.g., setting the operating power), setting the operating pressure of the VOC disposal system so that a desired residence time of the waste is achieved, setting the operating temperature of the VOC disposal system so that all components of the samples are sufficiently decomposed, and configuring the safety components. Other operations may be employed under the configuring operation 506.

An activating operation 508 activates the VOC disposal system. The activating operation 508 may include activating the plasma igniter, fans, pressure, control, and safety systems, or activating any other components of the VOC disposal system.

An introducing operation 510 introduces the waste sample to the VOC disposal system. The waste sample enters a plasma chamber of the VOC disposal system and begins reacting with the free radicals produced by the plasma igniters. Some components of the VOC disposal system will completely decompose in the plasma chamber. Other components will continue the decomposition process as the components travel from the plasma chamber to a vent chamber. The temperature of the VOC disposal system may be monitored and controlled by one or more heating elements.

A monitoring operation 512 monitors an output of the VOC disposal system. The monitoring operation 512 may be achieved by a number of sensors placed throughout the system and at an exhaust pipe of the system. A control system may log certain readings from the sensors. Components may be adjusted by the control system according to the readings from the sensors.

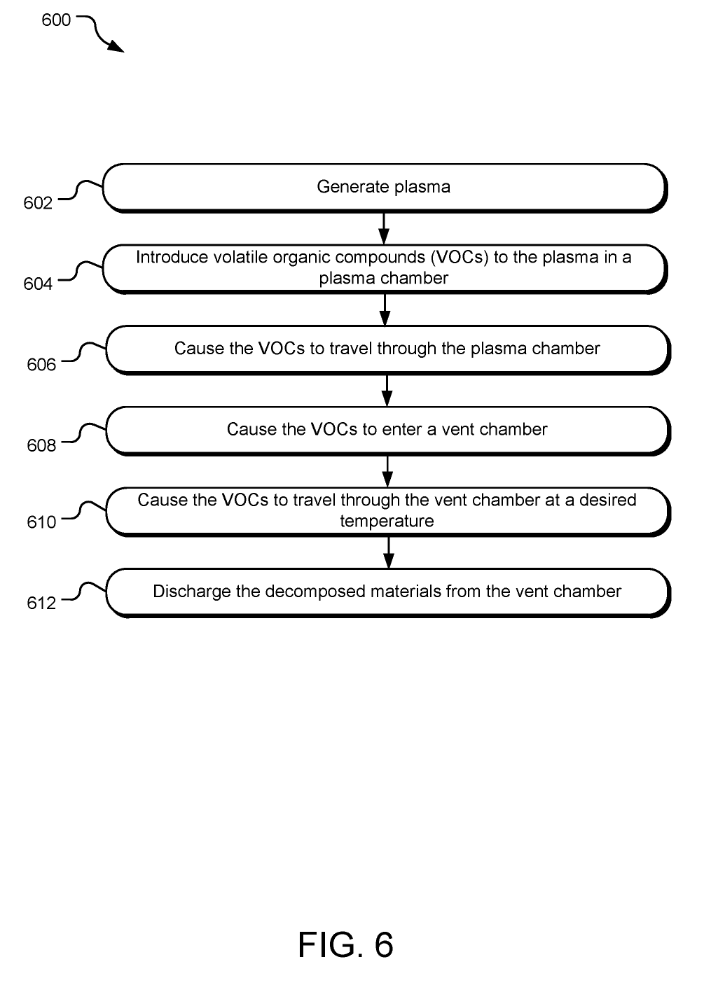

FIG. 6 illustrates alternative operations 600 for disposing of VOCs using the VOC disposal system disclosed herein. A generating operation 602 generates plasma. The generating operation may be achieved by one or more bands of plasma igniters placed along a plasma chamber. The plasma igniters may inject a stream of electrons into the interior of the plasma chamber, which causes various components of the plasma chamber to be ionized, generating a cone of cold plasma containing a field of free radicals The plasma may be generated in a manner such that the plasma may substantially fill a cross-sectional volume of the plasma chamber. An introduce operation 604 introduces volatile organic compounds (VOCs) to the plasma in the plasma chamber. The VOCs may begin decomposing due to interactions with the plasma in the plasma chamber.

A first cause operation 606 causes the VOCs to travel through the plasma chamber. The VOCs may travel due to a fan, pressure differences within the chamber or any other means. As the VOCs travel through the plasma chamber, they continue interacting with plasma and decomposing. A second cause operation 608 causes the VOCs to enter a vent chamber. The VOCs may be exhausted from the plasma chamber and may travel through a connecting pipe. The VOCs may travel for the same reasons as the first cause operation 606. A third cause operation 610 causes the VOCs to travel through the vent chamber at a desired temperature. A heating element may be attached to the vent chamber and configured to keep the operating temperature of the VOC disposal system at a desired point. The desired temperature may be responsive to the VOC composition or operating conditions. The VOCs may continue to decompose as they travel through the vent chamber. A discharge operation 612 discharges the decomposed materials from the vent chamber. The decomposed materials may be discharged into the atmosphere or into another system.

The above specification, examples, and data provide a complete description of the structure and use of exemplary implementations of the invention. Since many implementations of the invention can be made without departing from the spirit and scope of the invention, the invention resides in the claims hereinafter appended. Furthermore, structural features of the different implementations may be combined in yet another implementation without departing from the recited claims.

What is claimed is:

1. A method comprising:
generating a field of free radicals in a plasma chamber; and
injecting volatile organic compounds (VOCs) into the field of free radicals;
controlling the VOCs residence time in the plasma chamber;
exhausting the VOCs from the plasma chamber to a vent chamber connected to the plasma chamber.

2. The method of claim 1, wherein the field of free radicals is generated by one or more bands of plasma igniters.

3. The method of claim 2, wherein the one or more bands of plasma igniters are mounted on the plasma chamber.

4. The method of claim 2, wherein the one or more bands of plasma igniters includes plasma igniters mounted so as to generate electron streams at a non-zero angle compared to radius of the plasma chamber cross-section.

5. The method of claim 1, wherein a fan is connected to the vent chamber, the fan configured to flood the vent chamber and the plasma chamber in response to a spike in temperature.

6. The method of claim 1, wherein a heating element is connected to the vent chamber and configured to control an operating temperature of the VOC disposal system.

7. The method of claim 1, wherein the VOCs travel through the plasma chamber from a top end towards a bottom end of the plasma chamber.

8. The method of claim 7, wherein the VOCs are produced by an oil refinery and an operating temperature of a VOC disposal system is about 1550 degrees Fahrenheit to about 1650 degrees Fahrenheit.

9. A volatile organic compound (VOC) disposal system comprising:
a plasma chamber configured to generate a field of free radicals and receive the VOCs;
a vent chamber connected to the plasma chamber and configured to receive the VOCs from the plasma chamber.

10. The VOC disposal system of claim 9, wherein the field of free radicals is generated by one or more bands of plasma igniters mounted on the plasma chamber.

11. The method of claim 10, wherein the one or more bands of plasma igniters includes plasma igniters mounted so as to generate electron streams at a non-zero angle compared to radius of the plasma chamber cross-section.

12. The VOC disposal system of claim 9, wherein the VOCs are produced by an oil refinery and an operating temperature of the VOC disposal system is about 1550 degrees Fahrenheit to about 1650 degrees Fahrenheit.

13. The VOC disposal system of claim 9, wherein the VOCs are produced by a hospital and an operating temperature of the VOC disposal system is about 1400 degrees Fahrenheit to about 1500 degrees Fahrenheit.

14. The VOC disposal system of claim 9, wherein the VOC disposal system controls the residence time of the VOCS to approximately five seconds.

15. The VOC disposal system of 9, wherein the VOCs travel through the plasma chamber from a top end towards a bottom end of the plasma chamber.

16. A plasma chamber of a volatile organic compound (VOC) disposal system comprising:
one or more bands of plasma igniters positioned on the plasma chamber, each of the one or more bands of plasma igniters including a plurality of plasma igniters configured to inject a stream of electrons to generate a field of free radicals inside the plasma chamber,
wherein the streams of electrons generated by each of the plasma igniters interjects the streams of electrons generated by one or more of the other plasma igniters.

17. The plasma chamber of a VOC disposal system of claim 16, where an angle of each plasma igniter of the one or more bands of plasma igniters is adjustable along height of the plasma chamber and along circumference of the plasma chamber.

18. The plasma chamber of a VOC disposal system of claim 17, wherein the one or more bands of plasma igniters is further configured to generate the field of free radicals so as to substantially fill a cross sectional volume of the plasma chamber with free radicals.

19. The plasma chamber of a VOC disposal system of claim 16, wherein the one or more bands of plasma igniters comprises a first band and a second band, a first field of free radicals generated by the first band overlapping with a second field of free radicals generated by the second band.

20. The plasma chamber of a VOC disposal system of claim 16, wherein the one or more bands of plasma igniters includes plasma igniters mounted so as to generate electron streams at a non-zero angle compared to radius of the plasma chamber cross-section.
